(19) United States
(12) Patent Application Publication
(10) Pub. No.: US 2024/0339651 A1
(43) Pub. Date: Oct. 10, 2024

(54) CELL SEPARATION ELEMENT WITH SWELLING ADJUSTMENT AND BATTERY MODULE FOR A MOTOR VEHICLE

(71) Applicant: AUDI AG, Ingolstadt (DE)

(72) Inventors: Uwe GERLINGER, Kipfenberg (DE); Carsten LORENZ, Reichertshofen (DE); Eduard MAIN, Buxheim (DE)

(73) Assignee: AUDI AG, Ingolstadt (DE)

(21) Appl. No.: 18/599,365

(22) Filed: Mar. 8, 2024

(30) Foreign Application Priority Data
Apr. 5, 2023 (DE) 102023108766.5

(51) Int. Cl. H01M 10/04; H01M 10/613; H01M 10/625; H01M 10/6557; H01M 10/6567; H01M 50/249

(52) U.S. Cl. CPC H01M 10/0468; H01M 10/613; H01M 10/625; H01M 10/6557; H01M 10/6567; H01M 50/249; H01M 2220/20

(57) ABSTRACT

A cell separation element for arrangement in an intermediate space between two battery cells. The cell separation element is designed to be at least partially elastically compressible with respect to a first direction. The cell separation element has a first corrugated structural wall with a corrugated structure. When the cell separation element is arranged as intended in the intermediate space, a first side surface of the corrugated structural wall faces a first of the two battery cells and a second side surface of the corrugated structural wall faces a second of the two battery cells. The structural wall is designed to provide a restoring force when the cell separation element is compressed with respect to the first direction.

### FIELD

The invention relates to a cell separation element for arrangement in a space between two battery cells of a cell stack which are arranged adjacent to one another in a stacking direction, wherein the cell separation element is designed to be elastically compressible at least partially in relation to a first direction, which corresponds, when the cell separation element is arranged as intended in the space, to the stacking direction, wherein the cell separation element has a first corrugated structural wall with a corrugated structure, wherein when the cell separation element is arranged as intended in the space, a first side surface of the corrugated structural wall faces a first of the two battery cells and a second side surface of the corrugated structural wall faces a second of the two battery cells, and wherein the corrugated structural wall is designed to provide a restoring force when the cell separation element is compressed with respect to the first direction. Furthermore, the invention also relates to a battery module with such a cell separation element.

### BACKGROUND

Battery cells for vehicle batteries typically expand over the course of their service life, and the battery cells also cyclically swell and shrink as these battery cells are charged and discharged. This behavior is referred to as battery cell swelling. The battery cells in a cell stack should ideally be held in a defined installation space, which is typically achieved by a module housing in which such a cell stack is arranged. Furthermore, the battery cells should still be able to increase and decrease in swelling and this swelling of the cells should be counteracted with a certain counterforce. This is normally achieved by so-called cell separation elements, which are arranged in the spaces between the cells of a cell stack and which are accordingly designed to be at least partially flexible, in particular elastic or compressible. However, typical cell separation elements have relatively few options for adapting to cell-specific swelling behavior.

JP 2012-043655 A describes a cell separation element, which is also designed as a cooling element. This is intended to be arranged between two battery cells. In addition, this comprises numerous plates which extend in the direction of a flow direction and between which channels are formed through which a cooling medium can flow. The plates can be designed parallel to one another and at a distance from one another or can run in a zigzag shape. These numerous plates can be arranged between two lateral reinforcing plates which adjoin the battery cells providing the space.

There are also cooling plates that can be arranged between the battery cells. In order to additionally provide cooling between the cells, cooling plates that are incompressible are arranged between the cells in addition to cell separation elements, which requires additional installation space.

DE 10 2019 131 229 A1 describes a battery module for a motor vehicle in which intermediate layers are inserted into spaces between battery cells and which are metallic structures that have a relief structure. A temperature control agent or a pressure compensation compound can be arranged in a respective cavity formed by the relief structuring. They can also have a spring effect.

DE 10 2018 116 683 A1 describes a distance compensation element for arrangement between two components with a metal foil, with spring elements formed integrally with the metal foil, the spring elements protruding from the plane of the metal foil and the spring elements being formed to be in contact with at least one of the components.

Furthermore, DE 11 2016 004 919 T5 describes a heat exchanger that consists of a pair of plates that define a flow passage. The heat exchanger further includes a structural support member clamped between the pair of plates.

### SUMMARY

The object of the present invention is to provide a cell separation element and a battery module that are well adapted or adaptable to the swelling behavior of battery cells.

This object is achieved by a cell separation element and a battery module.

A cell separation element according to the invention for arrangement in a space between two battery cells of a cell stack which are arranged adjacent to one another in a stacking direction is designed to be elastically compressible at least partially in relation to a first direction, which corresponds, when the cell separation element is arranged as intended in the space, to the stacking direction, wherein the cell separation element has a first corrugated structural wall with a corrugated structure, wherein when the cell separation element is arranged as intended in the space, a first side surface of the corrugated structural wall faces a first of the two battery cells and a second side surface of the corrugated structural wall faces a second of the two battery cells, wherein the corrugated structural wall is designed to provide a restoring force when the cell separation element is compressed with respect to the first direction. The corrugated structure has a structural length that changes in at least a second direction, so that different restoring forces can be provided in different regions of the cell separation element.

The invention is based on the knowledge that most cell separation elements are designed in such a way that they usually counteract cell swelling with a force that is homogeneous when viewed across the contact surface. However, the swelling behavior across the surface of a typical battery cell is not homogeneous. Such a cell usually bulges much more in the middle than in the edge regions. A cell separation element, which makes it possible to apply forces, i.e. restoring forces, of different strengths, to such a cell in different regions during swelling, is therefore significantly better adapted to the swelling behavior of such a cell. This can also be made possible in a simple manner in that the cell separation element is designed with a corrugated structural wall, the corrugated structure of which varies at least in a second direction, more precisely, in which the structural length of this corrugated structure varies or changes in at least the second direction. A corrugated structure with a smaller structural length, i.e. more “corrugations” per unit length, counteracts an acting force with a significantly greater restoring force than a corrugated structure with a very large structural length. Due to the different restoring forces in different regions of the cell separation element, this can thus be designed to be differently flexible to external pressure forces in different regions. This advantageously makes it possible to adapt this flexibility to the inhomogeneous swelling behavior of the adjacent battery cells across the surface. Thus, for example, a battery cell can be opposed to with a significantly higher restoring force in a central region in which the swelling is strongest than in edge regions, or vice versa, the flexibility in the central region of the cell separation element can be greater than in edge regions in order to reduce the local pressure load on the cells in the central region where the swelling is strongest. The type of variation of the structural length of the corrugated structure across the structural wall can therefore be selected accordingly to adapt to the requirements and necessities of the respective battery cells of a cell stack. The cell separation element thus readily allows optimal adaptation and coordination to the swelling behavior of the battery cells in the cell stack.

The cell separation element is preferably intended for arrangement in a space between two prismatic battery cells or pouch cells. The cell separation element is preferably designed to be relatively flat, that is, it has a thickness in the first direction that is smaller than its length and width in the second direction and a third direction perpendicular thereto. Furthermore, the above-mentioned second direction should also be different from the above-mentioned first direction and in particular should be perpendicular thereto. The cell separation element is at least partially designed to be elastically compressible in the first direction, that is to say in the direction of its thickness. If the cell separation element is arranged as intended in the space between two cells of a cell stack, this first direction corresponds to the stacking direction of the cell stack. Regardless of whether the cell separation element is arranged in such a space or not, this is intended to express that the structural length of the corrugated structure varies in one direction, namely the second direction, which is perpendicular to that direction, namely the first direction, in which the cell separation element is at least partially designed to be elastically compressible.

A corrugated structure should be understood to mean, for example, a structure according to which the respective side surfaces of the corrugated structural wall alternately have elevations and depressions, at least with respect to the second direction. These elevations and depressions can be rounded. The corrugated structure can then, for example, have a kind of sinusoidal profile. A corrugated structure should also be understood to mean structures with a corrugation-like course. For example, the elevations and depressions on the respective side surfaces of the structural wall can also be tapered. For example, a zigzag structure should also be understood as a corrugated structure. A meander-shaped structure with at least rectangular elevations and depressions on a respective side surface of the structural wall should also be understood as a corrugated structure. The corrugated structure can also be referred to as a relief structure, for example. The first and second side surfaces are designed to be complementary with respect to this corrugated structure or relief structure. This means that where there is an elevation on the first side surface, there is a corresponding depression on the second side surface. In other words, the corrugated structural wall can be designed with an at least approximately constant wall thickness. The corrugated structural wall can, for example, be designed in a simple manner as a corrugated sheet metal. To produce such a corrugated sheet, a flat sheet can be inserted into a tool with a corrugated structure and provided with the desired corrugated structure, for example by pressing or deep drawing.

The structural length of the corrugated structure can be defined as the length of a structural element which is repeated in the same or similar way in the second direction to form the corrugated structure, wherein the structural element can represent an elevation and a depression. “Similarly” is intended to mean that this structural element can be similar to neighboring structural elements in terms of its geometry, but can also be enlarged or reduced in size, for example in terms of its dimensions, in particular its length. For example, the structural length can be understood as the wavelength of such a corrugated structure. Therefore, an advantageous embodiment of the invention is provided, if the varying structural length represents a varying wavelength of the corrugated structure. The wavelength, in particular local wavelength, can be defined, for example, as a distance between two mutually adjacent local maxima or two mutually adjacent local minima of the corrugated structure, for example in relation to a defined central plane of the structural wall. The same should apply if the corrugated structure is, for example, a zigzag structure or a meandering structure. Here too, a wavelength or, in general, a structural length can be defined quite analogously as the distance between two local minima or two local maxima that are adjacent to one another, i.e. are nearest neighbors.

As a result, different restoring forces can be provided in the different regions. The restoring forces refer to a force acting on the structural wall in the first direction. By varying the structural length, it can be achieved, for example, that in the case of a specific force acting on the structural wall in the first direction, a first restoring force is opposed to this force in a specific first region of the structural wall and a second restoring force is opposed in a second region of the structural wall region to the force acting with the same magnitude in the first direction, which second restoring force differs from the first restoring force in terms of its magnitude. In these two regions of the structural wall or of the cell separation element in general, which are in particular arranged offset from one another at least with respect to the second direction, different elasticity moduli or spring stiffnesses can therefore be provided. A longer structural length corresponds to a smaller spring stiffness and/or a smaller elastic modulus and a smaller structural length corresponds to a larger spring stiffness and/or a higher elastic modulus.

In general, one can therefore say that the corrugated structure has a first structural length in a first region of the structural wall and a second structural length in a second region of the structural wall, whereby a first modulus of elasticity or a first spring stiffness is assigned to the structural wall in the first region and a second modulus of elasticity that is different from the first modulus of elasticity or a second spring stiffness that is different from the first spring stiffness in the second region.

In a further advantageous embodiment of the invention, the corrugated structure, in particular the structural length, varies only in the second direction or additionally in a third direction. For example, the corrugated structure can be designed as a profiled corrugated structure, that is, the structural length only varies in the second direction. In this case, the corrugated structure may be the same in each cross section perpendicular to a third direction, which in turn is perpendicular to the first and second directions. The corrugated structural wall therefore has a constant profile in the third direction. This design has numerous advantages: On the one hand, it is particularly cost-effective to produce, since, for example, a corrugated sheet with varying structural length or wavelength can easily function as a corrugated structural wall. This simplifies manufacturing compared to manufacturing a wall with a three-dimensional corrugation profile. Another major advantage is that such a profiled corrugated structure can easily provide flow channels or cooling channels that run, for example, in the third direction, so that the cell separation element can also be used as a cooling element through which a coolant can flow, as will be explained in more detail later. Nevertheless, it is also conceivable that the corrugated structural wall is designed with a three-dimensional corrugated structure or with a corrugated structure that varies in two directions, which also has a varying structural length in two directions, namely the second and the third direction. This advantageously makes it possible to better adapt to the swelling behavior of the battery cells in both the second direction and the third direction. In addition, flow channels can also optionally be provided in this case.

In principle, it is also possible for the cell separation element to have or consist exclusively of the corrugated structural wall. If in this case the cell separation element is arranged in the space between two cells, the corrugated structural wall rests partly on the first battery cell and partly on the second battery cell or the corresponding cell walls delimiting the space. The corrugated structural wall does not lie flat against the cell sides of the battery cells, but only in regions, namely in relation to the first side surface in the regions in which the maxima of the corrugated structure are arranged on the first side surface and in relation to the second side surface of the corrugated structural wall only in the regions in which the maxima of the corrugated structure are arranged on the second side surface. In the case of a profile corrugated structure, as defined above, straight and linear contact regions then result between the first side surface and the adjacent first battery cell and, correspondingly, also between the second side surface and the adjacent second battery cell. This leaves spaces through which a cooling medium can flow, for example, as will be explained in more detail later.

In a particularly preferred embodiment of the invention, however, the cell separation element has a first plate and a second plate, in particular a flat first plate and a flat second plate, wherein the structural wall is arranged between the first plate and the second plate, so that the first side surface faces the structural wall of the first plate and the second side surface faces the structural wall of the second plate. The first side surface can contact the first flat plate in such a way as already described above with reference to the side surface of a battery cell. The same also applies to the contact between the second side surface of the structural wall and the second plate. The structural wall is therefore no longer arranged between the two plates, but is arranged on both sides of these two plates. The structural wall is therefore in direct physical contact with these adjacent two plates. The design with two such plates on both sides of the corrugated structural wall has the great advantage that the restoring forces can be distributed more evenly on the side surfaces of the adjacent battery cells. This allows local pressure increases to be efficiently avoided. This also enables the cell separation element to be designed as a closed cooling element through which a flow can pass. In other words, cooling channels are also formed between a respective plate and the corrugated structural wall, through which a cooling medium can flow, and these cooling channels can, for example, be brought together at their ends to form a common connection. The cell separation element can therefore be designed to be more easily sealed from the outside and, for example, can be designed with appropriate connections for the coolant supply and removal, as explained in more detail later.

A multi-layer structure is preferred, i.e. the provision of the two plates in addition to the structural wall in order to avoid high surface pressures at certain points. The sheets or plates and the structural wall can be welded together, glued together or joined together using another method.

In addition, the structural wall and the optional plate are designed with a small wall thickness, for example less than one millimeter. The plates are in particular designed to be so thin that a local deformation of the cell separation element is possible and/or at least the provision of different spring stiffnesses or restoring forces in different regions of the cell separation element is still possible. The plates can be provided, for example, as thin, flexible sheets.

In a further advantageous embodiment of the invention, the cooling wall is designed an element through which a coolant can flow. This has the great advantage that the cell separation element can also be used as a cooling device at the same time, in particular as an active cooling device. Typically, those sides of a battery cell that face such a cell separation element in a cell stack represent the largest sides of a battery cell in terms of surface area. If cooling is now provided by such a cell separation element, a very large region of such a battery cell can be actively cooled. This allows the performance of such a battery module to be increased enormously. Since the cooling device, which is provided by the cell separation element, can also be used for swelling compensation, no additional cell separation element is required and installation space can be saved. In addition, such a cooling device can create a very good thermal barrier between the cells in the event of thermal runaway of a battery cell in order to prevent thermal spread of such thermal runaway to neighboring cells. Additional propagation-preventing intermediate cell layers can therefore also be saved.

It is advantageous in this case if the cell separation element is designed in such a way that a coolant can flow through it at least in a third direction, which is perpendicular to the first and second directions. As described above, this can be achieved in a particularly simple manner, since the corrugated structure varies at least in the second direction. In other words, the corrugated structural wall can, for example, only be designed to be corrugated along its course in the second direction, while in relation to a third direction perpendicular thereto, the structural wall can be designed with a constant profile. This automatically results in cooling channels running in the third direction, which can now advantageously be used to simultaneously provide a cooling element through the cell separation element. In this case, the cell separation element is designed as an intercell cooling element. But even in the case of a three-dimensional corrugated structure, that is to say a corrugated structural wall that runs in a corrugated shape in both the second direction and the third direction, flow-through spaces can be formed by suitable design of the corrugated structure.

In both cases, it is also conceivable that the structural wall itself is provided with through openings or holes that extend from the first side surface to the second side surface. This allows a flow through the structural wall itself. The corrugated structural wall can also be perforated.

This advantageously also enables fluid exchange between the individual cooling channels, which are formed between the structural wall and the adjacent component, for example one of the plates or a cell wall. If it is desired to mix the fluid flow on both sides, the corrugated sheet metal, ie the structural wall, can be perforated or designed to be perforated.

In a further advantageous embodiment of the invention, cooling channels through which a coolant can flow are formed between the first and/or the second plate and the structural wall. As already described above, the cell separation element can be easily designed as a closed intercell cooling element. However, the flow-through cooling channels provided in this way can also be open at their ends, that is to say in the region of the end faces of the cell separation element in relation to the third direction and/or possibly also to the second direction. This makes it possible to achieve both an open flow around the battery cells and flow through the cell separation element, as well as a design as a closed cooling element that can be flowed through.

In a further embodiment of the invention, the structural wall is designed in such a way that, when arranged in the space between the structural wall and the battery cells, cooling channels through which a coolant can flow are formed. In other words, the cell separation element is designed without the two plates, and if the corrugated structural wall is arranged directly in the space between two battery cells, cooling channels which can be flowed through are formed in a completely analogous manner between the respective cell sides and the side surfaces of the corrugated structural wall. The design as a closed cooling unit is somewhat more difficult in this case, so that in this case the design with an open flow through the cell stack with the cell separation elements arranged in the space is preferred.

In a further advantageous embodiment of the invention, the cell separation element has a coolant supply connection and a coolant discharge connection. This is particularly advantageous if the cell separation element comprises the additional two flat plates described above on both sides of the corrugated structural wall. The front ends of the channels of the cell separation element, which lie opposite one another with respect to the third direction, for example, can be connected to a collection device of the cell separation element on the one hand and a distribution device of the cell separation element on the other hand. A connection, for example a connection piece, for coolant supply and discharge can each be provided in the collection device and the distribution device. The arrangement of the two plates with the interposed corrugated structural wall can therefore be connected at its ends on both sides with respect to the third direction to a collection device of the cell separation element on the one hand and a distribution device of the cell separation element on the other hand. The collection device and the distribution device can each comprise a connection, namely the distribution device the coolant supply connection and the collection device the coolant discharge connection. The coolant, preferably a cooling liquid, supplied via the coolant supply connection is distributed to the individual cooling channels via the distribution device. The coolant then flows through the cooling channels and reaches the collection device and is discharged again via the coolant discharge connection located there. The collection device and the distribution device can be designed as a walled fluidic connection of the cooling channels. This makes it easy to provide a closed cooling element.

Furthermore, it is preferred that the cell separation element is designed in such a way that the collection unit and the distribution unit protrude from this space on both sides with respect to the third direction when the cell separation element is arranged as intended in a cell stack or in a space between two battery cells. This makes it easier to attach the supply and discharge lines to the corresponding connections.

In a further advantageous embodiment of the invention, the cell separation element is made of one or more metallic materials. For example, the cell separation element including all of its components can be made of metal. In particular, at least the corrugated structural wall and the two optional plates should be made of such a metallic material, for example aluminum or steel. This has the great advantage that it enhances the optional cooling function of the cell separation element, since metal is a very good thermal conductor.

In a further advantageous embodiment of the invention, the cell separation element or at least the corrugated structural wall and the two optional plates are made of a plastic material, in particular fiber-reinforced plastic. This results in a very lightweight cell separation element.

The sheets, ie the plates and/or the structural wall, are preferably made of aluminum, but a structure made of other materials or combinations of materials, for example aluminum, plastic, aluminum, is also conceivable, that is, the plates can be made of aluminum and the corrugated structural wall can be made of plastic.

Therefore, in a further advantageous embodiment of the invention, the cell separation element is partially formed from one or more metallic materials and partially formed from a plastic, in particular fiber-reinforced plastic or unreinforced plastic, in particular wherein the structural wall is made of plastic and the first and second plates are made of the one or more metallic materials. This has the great advantage that the two metallic plates, which in their intended installation position within a cell stack directly adjoin the cell walls of the battery cells providing the intermediate space, allow heat to be dissipated very well from the cells via the coolant flowing through the cooling channels, since, as described, metal is a very good thermal conductor. This means that the cooling function can be optimized. At the same time, it is possible to provide a thermal insulation layer between two battery cells adjacent to one another in a cell stack through the structural wall made of plastic. This is particularly advantageous in the event of thermal runaway of such a battery cell. Nevertheless, the coolant flowing through the cooling channels or the coolant present in the cooling channels can already provide a very good thermal barrier in the event of a thermal runaway of such a battery cell. Thermal propagation can thereby be prevented or at least made more difficult.

In a further advantageous embodiment of the invention, the structural length in a central region of the structural wall relative to the second direction is greater than in an edge region of the structural wall relative to the second direction, in particular wherein the structural length from the central region in the direction of the edge regions relative to the second direction decreases monotonically. This has the great advantage that larger restoring forces can be provided when force is applied to the cell separation element, especially in the central region of the cell separation element. In the case of cell swelling, the swelling forces are particularly large in the central region of cell walls of adjacent battery cells, as the battery cells bulge very strongly here. Therefore, a very large restoring force can in particular be provided to the cells in this region. As a result, the cell separation element can be designed in such a way that the expansion of the cells in the central region is particularly strongly suppressed so that the adjacent cells deform evenly across the surface.

In a further advantageous embodiment of the invention, the structural length in a central region of the structural wall is smaller in relation to the second direction than in an edge region of the structural wall in relation to the second direction in particular wherein the structural length increases monotonically from the central region towards the edge regions, in relation to the second direction. In this case, the cell separation element is designed in such a way that the greater expansion of the cells in the central region is subject to a lower resistance. This means that the cell can expand more easily in the central region, i.e. where more space is required for such expansion due to the strong swelling behavior of the cells.

It can also be the case that the structural length changes equally starting from the central region to the edge regions opposite in the second direction, that is, symmetrically or asymmetrically. For example, it may be that the length of the path decreases or increases significantly faster towards a first edge region than towards an opposite second edge region.

In addition, the statements regarding the change in the structural length apply not only to the second direction, but optionally additionally or alternatively also to the third direction.

In a further advantageous embodiment of the invention, the structural length in a central region of the structural wall is smaller in relation to the second direction than in a first edge region of the structural wall in relation to the second direction and larger than in a second edge region of the structural wall opposite the first edge region in relation to the second direction, in particular wherein the structural length decreases monotonically from the first edge region to the second edge region. It is therefore not only possible for the structural length to decrease or increase in the same way starting from the central region to the edge regions, but a monotonous structural length gradient can also be implemented from one edge region to the opposite edge region. Such a cell separation element is suitable, for example, for battery cells that exhibit asymmetrical swelling behavior and, for example, swell significantly more in one edge region than in the opposite edge region.

By varying the wavelength of the central corrugated sheet, ie the structural wall, different mechanical properties, in particular different spring characteristics, can generally be adjusted, in particular locally or in regions.

Furthermore, the invention also relates to a battery module for a motor vehicle, in particular for a high-voltage battery of a motor vehicle, wherein the battery module comprises a cell stack with at least two battery cells arranged adjacent to one another in a stacking direction, as well as a cell separation element according to the invention or one of its embodiments, wherein the cell separation element is arranged in the space between the two battery cells.

In a further advantageous embodiment of the invention, at least one cooling channel through which a coolant can flow is provided by the structural wall arranged in the intermediate space, wherein the battery module has a receptacle in which the cell stack is at least partially arranged, so that at least two open ends of the cooling channel of the structural wall are arranged in the receptacle, wherein the receptacle can be flowed through by a coolant in such a way that the part of the battery cells arranged in the receptacle is in direct contact with the coolant flowing through the receptacle and the coolant flows through the cooling channel.

In this case, cooling is provided as open flow cooling. In other words, in this case the coolant can come into direct contact with the battery cells. The receptacle is therefore preferably designed to be fluid-tight, so that the preferably liquid coolant cannot leak. For example, if the entire cell stack is located within this receptacle or has coolant flowing around it, an electrically non-conductive coolant, for example an oil, can be used as the coolant. A gas, although less preferred, can also be used as a coolant. However, it can also be the case that only a part of the battery cells is arranged in the receptacle or a part of a respective battery cell included in the cell stack, wherein this part of the battery cell arranged in the receptacle does not represent the part on which the cell poles are arranged. In other words, the cell housings can also be designed to be electrically insulated from the outside and the cell poles can be positioned outside the receptacle through which the coolant flows. In this case, an electrically conductive coolant, for example water or water with additives or another water-based coolant, can also be used.

The invention also includes developments of the battery module according to the invention, which have the same features which have already been described in conjunction with the developments of the cell separation element according to the invention. For this reason, the corresponding developments of the battery module according to the invention are not described again here.

Furthermore, the invention also relates to a high-voltage battery for a motor vehicle, which battery has at least one battery module according to the invention or one of its embodiments. Furthermore, the invention also relates to a motor vehicle having a battery module according to the invention or one of its embodiments.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic cross-sectional illustration of a battery module according to an exemplary embodiment of the invention;

FIG. 2 shows a schematic illustration of a main part of a cell separation element according to an exemplary embodiment of the invention.

FIG. 3 shows a schematic illustration in a view from above of a battery cell and of a cell separation element according to an exemplary embodiment of the invention;

FIG. 4 shows a schematic illustration of a main part of a cell separation element according to a further exemplary embodiment of the invention;

FIG. 5 shows a schematic representation of a main part of a cell separation element according to a further exemplary embodiment of the invention;

FIG. 6 shows a schematic representation of a main part of a cell separation element according to a further exemplary embodiment of the invention.

FIG. 7 shows a schematic representation of a battery module in a plan view with an open cooling according to an exemplary embodiment of the invention; and

FIG. 8 shows a schematic representation of a cell separation element designed as an inter-cell cooling element with cooling connections according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

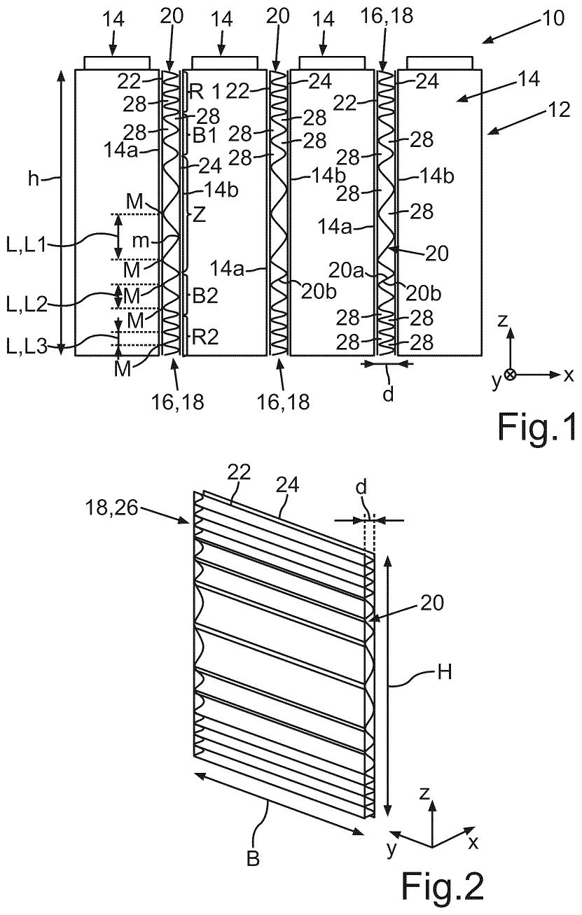

FIG. 1 shows a schematic illustration of a cross section of a battery module 10 according to an exemplary embodiment of the invention. The battery module 10 has a cell stack 12 with a plurality of battery cells 14 arranged next to one another in a stacking direction x. A space 16 is provided between two adjacent battery cells 14 arranged in relation to each other, in which a cell separation element 18 is arranged according to an exemplary embodiment of the invention. The side surfaces of the battery cells 14 facing each other in the cell stack 12 are designated 14a and 14b. The cell separation element 18 is designed to be elastically compressible at least with respect to the x direction shown. For this purpose, the cell separation element 18 comprises a corrugated structural wall 20 which has a corrugated structure. This structural wall 20 has a first side surface 20a, which faces a first side wall 14a of a battery cell 14 arranged adjacent to the cell separation element 18, and a second side surface 20b, which faces a second side wall 14b of the battery cells 14 adjacent to the cell separation element 18.

In this example, the cell separation element 18 also comprises a first flat plate 22 and a second flat plate 24, between which the structural wall 20 is arranged. This multi-layer structure has the advantage that high surface pressures can be avoided. This allows a smooth contact surface to be produced for the cells 14, in particular for the cell walls 14a, 14b. However, depending on the embodiment, these side walls 22, 24 are merely optional.

Due to the corrugated structure of the structural wall 20, it is now advantageously possible to provide a restoring force when the cell separation element 18 is compressed in the x direction. The structural wall 20 is now advantageously designed such that this restoring force varies in the z direction in the present example. This is due to the fact that the corrugated structure of the structural wall 20 has a structural length L that changes in at least one direction, in the present example in the z direction. To simplify matters, the cell separation element 18 or the structural wall 20 can be divided into several regions, as in this example in the z direction, namely a central region Z, a first edge region R1 and a second edge region R2 opposite the first edge region R1 with respect to the z direction. Between the central region Z and the respective edge regions R1, R2, two respective intermediate regions B1, B2, namely an upper intermediate region B1 and a lower intermediate region B2, are illustrated as examples based on the illustration in FIG. 1 However, this division into the corresponding regions can apply not only to the cell separation element 18 or the structural wall 20, but also, for example, to the corresponding side surfaces 14a, 14b of the battery cells 14. In addition, this division into these corresponding regions is now in relation to the z-direction been made. Alternatively, this could just as well be implemented in the y-direction or optionally also in the y-direction.

In this example, the corrugated structure of the structural wall 20 is designed such that the corrugated structure in the central region Z has a first structural length L1, which is greater than a third structural length L3 in the second edge region R2, and in particular also greater than a second structural length L2 in the second transition region B2. In particular, the structural length decreases, in particular monotonically, starting from the central region Z towards both edge regions R1, R2. This means that the second structural length L2 is also greater than the third structural length L3 in the second edge region R2. Furthermore, the structural length L in the first edge region R1 can be as large as in the second edge region R2, and the structural length in the first transition region B1 can also be as large as in the second transition region B2. In this example, the variation of the structural length L is symmetrical starting from the central region Z towards the edge regions R1, R2. An asymmetrical design is also conceivable.

The structural length L represents, so to speak, a wavelength L of this corrugated structure. In the present example, the structural length L is defined as the distance between two mutually adjacent maxima M of the corrugated structure, for example based on the first side surface 20a. However, it could also be defined as the distance between two minima m based on the first side surface 20a. A maximum M of the first side surface 20a is located at the same z coordinate as a minimum of the second side surface 20b, although for reasons of clarity this is not illustrated by reference numerals here. In addition, for reasons of clarity, only some of the maxima M and one of the minima m of the first side surface 20a are provided with a reference number, in particular only with reference to one of the corrugated structural walls 20 of the battery module 10.

By varying the wavelength or structural length L of the central corrugated sheet 20 or generally the corrugated structural wall 20, different mechanical properties, in particular spring characteristics, can be set. This makes it possible, for example, as in this exemplary embodiment, to provide less resistance to the adjacent cell 14 in regions with stronger swelling behavior, namely the central region Z, due to the large wavelength L1 in the central region Z.

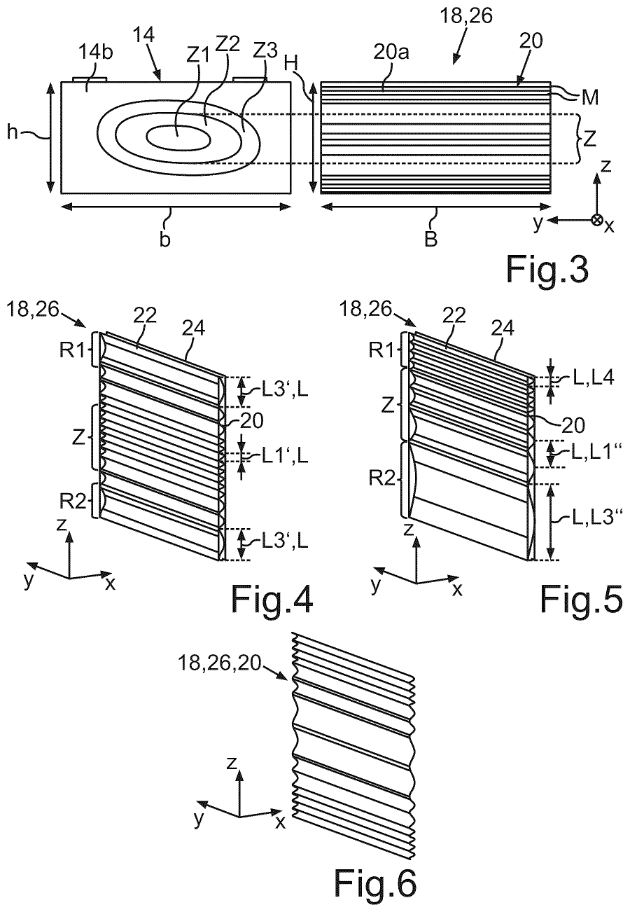

FIG. 2 shows again a schematic and perspective view of a cell separation element 18 or a main part 26 of the cell separation element 18 according to an exemplary embodiment of the invention, in particular as described in FIG. 1. The cell separation element 18 can also have additional components, for example connections for coolant supply and removal, as will be explained in more detail later. FIG. 2 therefore illustrates at least the central part of such a cell separation element 18, which is also referred to as the main part 26, and which represents at least the part of the cell separation element 18 which is or is arranged in the space 16 between the cells 14. The cell separation element 18 can, for example, only be designed as this main part 26. The main part 26 has a thickness d that is smaller than a width B in the y-direction and a height H in the z-direction of the coordinate system shown. The height H can, for example, correspond to a height h of a battery cell 14 (see FIG. 1) or to the height h of the space 16 provided between the battery cells 14. The width B can correspond to a width b (see FIG. 3) of a respective battery cell 14 or the space 16 correspond. In this example, the cell separation element 18 therefore comprises two outer sheets, which are provided by the plates 22, 24, and a corrugated sheet, which provides the corrugated structural wall 20. In the edge region R1, R2, the smaller wavelengths L make it possible to transmit higher forces. The large wavelength L1 in the central region Z offers the cell 14 less resistance in regions with stronger swelling behavior, as will be illustrated again with reference to FIG. 3.

FIG. 3 shows a schematic representation of a top view of a battery cell 14 and a top view of the main part 26 of a cell separation element 18. In this example, the cell separation element 18 or its structural wall 20 is designed such that the structural wall 20 has a constant profile in the y-direction having. The lines shown in FIG. 3 for the cell separation element 18, which run horizontally or parallel to the y-axis, illustrate the maxima M of the corrugated structural wall 20. Here too, only some of these maxima M are provided with a reference number. Z again denotes the central region of the cell separation element 18, as well as the corresponding central region Z of the battery cell 14. In addition, the swelling behavior is also illustrated for the battery cell 14. The region Z1 defines the region of the cell 14 or the cell wall 14b that has the strongest swelling behavior and therefore expands the most. In other words, the cell 14 has its greatest thickness in the region Z1 in relation to the x direction. This applies at least to a swollen cell 14. The cell 14 shows a somewhat weaker swelling behavior in the second region Z2 and an even weaker one in the third region Z3, with the swelling behavior in the third region Z3 being significantly more pronounced than in the other edge regions of the cell 14. The variation of the wavelength L of the corrugated structure of the structural wall 20 is thus optimally adapted to the variation of the swelling of the cell 14 across its side surface 14b.

It should also be noted here that a variation of the wavelength L can be provided not only in the z-direction, but alternatively or additionally also in the y-direction. By means of an additional variation in the y-direction, an adaptation to the inhomogeneous swelling behavior of the cell 14 in the y-direction can in particular also be taken into account.

However, it is not only possible to design the cell separation element 18 or its main part 26 in such a way that the cell 14 in the central region Z is opposed by lower restoring forces due to the correspondingly increased wavelength L1, but other variants are also conceivable, which are now based on FIG. 4 and FIG. 5 will be explained.

FIG. 4 shows the main part 26 of a cell separation element 18 according to a further exemplary embodiment of the invention. This can be designed as described above, except for the differences described below, which mainly relate to the type of variation of the wavelength L of the corrugated structure of the structural wall 20. In this example, the cell separation element 18 and the structural wall 20 in the central region Z have the smallest wavelength L1′, which increases towards the boundary regions R1, R2. The wavelength in the edge regions R1, R2 is designated L3′ in the present case and can be the same for both edge regions R1, R2 as in this example. In this example, the variation of the wavelength L from the central region Z to the edge regions R1, R2 is symmetrical. In addition, it increases monotonically from the central region Z to the edge regions R1, R2.

FIG. 5 shows a schematic representation of a main part 26 of a cell separation element 18 according to a further exemplary embodiment of the invention, in which example the structural wall 20 shows an asymmetrical structure with regard to the variation of the wavelength L. And symmetrical here again refers to the central region Z. In particular, the wavelength L increases from the upper edge region R1 to the lower edge region R2. In the upper margin region R1, the corrugated structure thus has the smallest wavelength L4, in the central region Z a medium wavelength L1″ and in the lower margin region R2 the largest wavelength L3″.

Although a multi-layer structure of the main part 26 of the cell separation element 18 is preferred, there is also the option of omitting the above-mentioned plates 22, 24. This is shown as an example in FIG. 6. This shows a schematic representation of a cell separation element 18 or its main part 26, which only consists of the structural wall 20. In particular, the entire cell separation element 18 can only consist of this structural wall 20. This can be designed as described above.

The cell separation element 18 described can not only advantageously provide flexibility or restoring forces adapted to the swelling behavior of the cells 14, but the cell separation elements 18 described can also advantageously optionally also provide a cooling function. In particular, the cell separation element 18 can also be designed so that a coolant can flow through it. For this purpose, reference is made again to FIG. 1 in the description. Between the structural wall 20 and the plates 22, 24 arranged on both sides of it, cavities arise through which a coolant can flow and can accordingly be used as cooling channels 28. In this example, these extend in a straight line in the y direction. In principle, these can also be designed differently. In addition, the structural wall 20 can be perforated or have several holes in order to allow flow between the cooling channels 28. Even without the provision of the two side plates 22, 24, such channels 28 can be formed between the structural wall 20 and the adjacent sides 14a, 14b of the cells 14. These cavities can also be used as cooling channels 28.

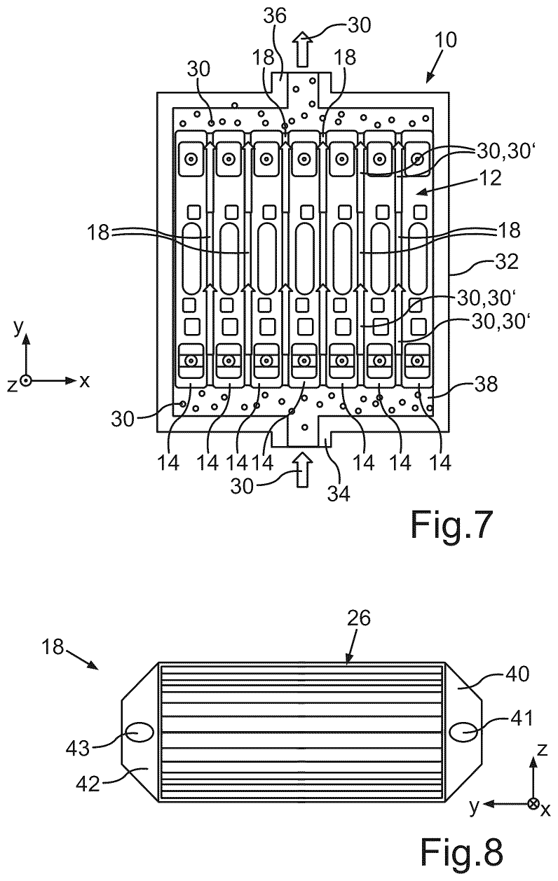

FIG. 7 shows a schematic representation of a battery module 10 according to an exemplary embodiment of the invention in a top view, through which a coolant 30 flows, which is also partly illustrated by arrows 30. The arrows 30 point in the flow direction of the coolant 30. The battery module 10 has, for example, a receptacle 32 in which the cell stack 12 with the cell separation elements 18 arranged between the cells 14, which have the cooling channels 28 just described, is arranged. The receptacle 32 has, for example, a coolant supply connection 34 and a coolant discharge connection 36. Via the supply connection 34, the coolant 30 can be inserted into the interior 38 of the receptacle 32, in which the cell stack 12 with the cell separation elements 18 is also located. Within this space 38, coolant 30 may move freely and flow around cells 14, as well as cooling channels 28 of cell separation elements 18 may flow through, with the flow of these cooling channels 28 additionally designated as 30′. A corresponding pressure gradient can be provided between the connections 34, 36 in order to achieve this through flow. In other words, in this example, the cell pack 12 is located directly in the fluid 30. Due to the pressure difference between the flow and return, that is, between the fluid 30 supplied at the supply connection 34 and the fluid 30 discharged at the discharge connection 36, the cooling fluid 30 flows between the cells 14 through the cooling plates 18.

Alternatively, each cooling plate, that is, each cell separation element 18, could also be provided with a connection for flow and return, as shown schematically in FIG. 8.

FIG. 8 shows a schematic illustration of a cell separation element 18 in a top plan view according to a further exemplary embodiment of the invention. The previously described main part 26 of the cell separation element 18 is in the present case still arranged between a collecting unit 40 with a nozzle 41 and a distribution unit 42 with a nozzle 43. The fluid 30 can be supplied to the distribution unit 42 via the feed connection 43. The supplied fluid 30 is supplied via this to the individual cooling channels 28 within the main part 26. After the fluid 30 has passed through these channels 28, it flows around the collecting unit 40, via which it is removed again via the discharge supports 41. In this case, intercell cooling is made possible in which the fluid 30 flowing through the cooling unit provided by the cell separation element 18 cannot come into direct contact with the cells 14.

Overall, the examples show how the invention can provide intercell cooling and a corrugated sheet metal structure with non-uniform wavelength of the corrugated sheet. By using a corrugated sheet metal structure with uneven wavelength as a spacer for battery systems with intercell cooling, the mechanical resistance across the surface can be variably adapted to the swelling behavior of the cell. This allows the cell to either be given targeted space for swelling or to be counteracted by a deliberately higher spring force. The region of strong swelling can be adjusted so that the corrugated sheet structure either prefers or suppresses expansion so that the cell deforms evenly across the surface.

1. A cell separation element for arrangement in an intermediate space between two battery cells of a cell stack which are arranged adjacent to one another in a stacking direction,
wherein the cell separation element is designed to be elastically compressible at least in part with respect to a first direction, which corresponds to the stacking direction in the intermediate space,
wherein the cell separation element has a first corrugated structural wall with a corrugated structure,
wherein, when the cell separation element is arranged as intended in the intermediate space, a first side surface of the corrugated structural wall faces a first of the two battery cells and a second side surface of the corrugated structural wall faces a second of the two battery cells,
wherein the corrugated structural wall is designed to provide a restoring force when the cell separation element is compressed, with respect to the first direction,
wherein the corrugated structure has a structural length that changes in at least a second direction, so that different restoring forces can be provided in different regions of the cell separation element.

2. The cell separation element according to claim 1, wherein the varying structural length represents a varying wavelength of the corrugated structure, in particular wherein the wavelength is defined as a distance between two adjacent local maxima or two local minima of the corrugated structure with respect to a defined central plane of the structure wall.

3. The cell separation element according to claim 1, wherein the corrugated structure, in particular the structural length, varies only in the second direction or also varies in a third direction.

4. The cell separation element according to claim 1, wherein the cell separation element has a first plate and a second plate, wherein the structural wall is arranged between the first plate and the second plate, so that the first side surface of the structural wall faces the first plate and the second side surface of the structural wall faces the second plate.

5. The cell separation element according to claim 1, wherein the cell separation element is designed so that a coolant can flow through it, at least in a third direction, which is perpendicular to the first and second directions, in particular
wherein cooling channels, through which a coolant can flow, are formed between the first and/or the second plate and the structural wall;
wherein the structural wall is designed such that when arranged in the intermediate space between the structural wall and the battery cells, cooling channels, through which a coolant can flow, are formed.

6. The cell separation element according to claim 1, wherein the cell separation element has a coolant supply connection and a coolant discharge connection.

7. The cell separation element according to claim 1, wherein the cell separation element:
is made of one or more metallic materials,
is made of a plastic, in particular fiber-reinforced plastic, or
is partially formed from one or more metallic materials and partially formed from a plastic, in particular wherein the structural wall is made of the plastic and the first and second plates are made of the one or more metallic materials.

8. The cell separation element according to claim 1, wherein
the structural length in a central region of the structural wall relative to the second direction is greater than in an edge region of the structural wall relative to the second direction, in particular wherein the structural length decreases monotonically from the central region in the direction of the edge regions with respect to the second direction; or
the structural length in a central region of the structural wall relative to the second direction is smaller than in an edge region of the structural wall relative to the second direction, in particular wherein the structural length increases monotonically from the central region in the direction of the edge regions with respect to the second direction; or
the structural length in a central region of the structural wall relative to the second direction is smaller than in a first edge region of the structural wall relative to the second direction and is larger than in a second edge region of the structural wall which is opposite the first edge region with respect to the second direction, in particular wherein the structural length decreases monotonically from the first edge region to the second edge region.

9. A battery module for a motor vehicle, with a cell stack, which comprises at least two battery cells arranged adjacent to one another in a stacking direction, and a cell separation element according to claim 1, wherein the cell separation element is arranged in a space between the two battery cells.

10. The battery module according to claim 9, wherein at least one cooling channel, through which a coolant can flow, is provided by the structural wall arranged in the intermediate space, wherein the battery module has a receptacle, in which the cell stack is at least partially arranged, so that at least two open ends of the cooling channel of the structural wall are arranged in the receptacle, wherein the receptacle can be flowed through by a coolant in such a way that the part of the battery cells arranged in the receptacle is in direct contact with the coolant flowing through the receptacle and the coolant flows through the cooling channel.

11. The cell separation element according to claim 2, wherein the corrugated structure, in particular the structural length, varies only in the second direction or also varies in a third direction.

12. The cell separation element according to claim 2, wherein the cell separation element has a first plate and a second plate, wherein the structural wall is arranged between the first plate and the second plate, so that the first side surface of the structural wall faces the first plate and the second side surface of the structural wall faces the second plate.

13. The cell separation element according to claim 3, wherein the cell separation element has a first plate and a second plate, wherein the structural wall is arranged between the first plate and the second plate, so that the first side surface of the structural wall faces the first plate and the second side surface of the structural wall faces the second plate.

14. The cell separation element according to claim 2, wherein the cell separation element is designed so that a coolant can flow through it, at least in a third direction, which is perpendicular to the first and second directions, in particular
wherein cooling channels, through which a coolant can flow, are formed between the first and/or the second plate and the structural wall;
wherein the structural wall is designed such that when arranged in the intermediate space between the structural wall and the battery cells, cooling channels, through which a coolant can flow, are formed.

15. The cell separation element according to claim 3, wherein the cell separation element is designed so that a coolant can flow through it, at least in a third direction, which is perpendicular to the first and second directions, in particular
wherein cooling channels, through which a coolant can flow, are formed between the first and/or the second plate and the structural wall;
wherein the structural wall is designed such that when arranged in the intermediate space between the structural wall and the battery cells, cooling channels, through which a coolant can flow, are formed.

16. The cell separation element according to claim 4, wherein the cell separation element is designed so that a coolant can flow through it, at least in a third direction, which is perpendicular to the first and second directions, in particular
wherein cooling channels, through which a coolant can flow, are formed between the first and/or the second plate and the structural wall;
wherein the structural wall is designed such that when arranged in the intermediate space between the structural wall and the battery cells, cooling channels, through which a coolant can flow, are formed.

17. The cell separation element according to claim 2, wherein the cell separation element has a coolant supply connection and a coolant discharge connection.

18. The cell separation element according to claim 3, wherein the cell separation element has a coolant supply connection and a coolant discharge connection.

19. The cell separation element according to claim 4, wherein the cell separation element has a coolant supply connection and a coolant discharge connection.

20. The cell separation element according to claim 5, wherein the cell separation element has a coolant supply connection and a coolant discharge connection.
